(19) United States
(12) Patent Application Publication
(10) Pub. No.: US 2009/0020280 A1
(43) Pub. Date: Jan. 22, 2009

(54) PASSENGER COMPARTMENT HEATING

(75) Inventor: Jonas Nathaniel Janek, Alton, IL (US)

Correspondence Address: FISH & RICHARDSON P.C., P.O BOX 1022, Minneapolis, MN, 55440-1022, US

(73) Assignee: SUPPLEMENTAL AUTOMOTIVE HEATING SYSTEMS, LLC, Springfield, IL (US)

(21) Appl. No.: 11/778,342

(22) Filed: Jul. 16, 2007

(51) Int. Cl. B60H 1/00

(52) U.S. Cl. 165/202; 237/12.3 R

(57) ABSTRACT

A vehicle heating system, and method, for heating a passenger compartment. The heating system has a heat control switch operable to activate the heating system, a fat producing airflow, a ventilation system directing the airflow throughout the passenger compartment and a heater core having a temperature sensor. The heater core is disposed behind the fan, such that air passes through, and is heated by the heater core prior to entering the fan. A supplemental heating element is disposed in an airflow path of the heating system. Air flow produced by the fan passes through the supplemental heating element before passing through the ventilation system to heat the passenger compartment. The heating system has a control unit, which controls current flow to the supplemental heating element based on the inputs received from the vehicle's ignitions switch, the temperature sensor, and the heat control switch.

### TECHNICAL FIELD

This invention relates to heating a passenger compartment of a vehicle.

### BACKGROUND

Heating systems used in vehicles generally feature a liquid heat exchanger (heater core) that is heated by radiator fluid, which derives its heat from an engine that produces heat by friction and combustion. A blower fan moves air through, the heater core, where it is warmed, and then into a passenger compartment of the vehicle. Engines can take several minutes to reach a temperature high enough to open a thermostat valve to allow the warm radiator fluid to circulate through the heater core.

### SUMMARY

In one aspect, a vehicle passenger compartment heating system has a fen that produces air flow, and a heater core that receives heated heating fluid and is disposed upstream of the fan, such that air is drawn through the heater core by the fan for heat exchange with the heating fluid. The heating system also includes a ventilation system directing the air flow produced by the fan throughout the passenger compartment, a supplemental heating element disposed in the ventilation system and arranged to heat air flow produced by the fan, and a heating system controller that controls electrical power to the supplemental heating element as a function of a state of an operable activation switch and a sensed heating-fluid temperature.

In another aspect a method of modifying a factory vehicle heating system in a vehicle having a passenger compartment includes placing a heating element in a factory air box between a factory blower fan and the passenger compartment, installing a temperature sensor to sense a heater core temperature, and providing a controller such that the controller controls the provision of power to the heating element as a function of at least a state of an operable activation switch for the heating system and sensed heater core temperature.

In another aspect, a method of fitting a vehicle heating system including placing a heating element in a factory air box between a factory blower fan and a passenger compartment, installing a temperature switch on a factory heater core to sense a heating fluid temperature in the core, and connecting a switch to the heating element such that electrical power is provided to the heating element as a function of at least a state of an operable activation switch for the heating system and sensed heating fluid temperature.

One or more of the following features may also be included. The supplemental heating element is disposed downstream of the fan. The controller is configured to provide power to the supplemental heating element only when the activation switch is engaged and the sensed temperature is less than about 160° F. for example less than about 140° F. The supplemental heating element is operably connected to a battery that supplies electrical power to the heating system. The battery can be an auxiliary battery that provides power essentially only to the heating system. The controller includes one or more relay switches connecting the supplemental heating element to the battery and controlled by heating fluid temperature and the activation switch. The controller includes a microprocessor running a program that analyzes inputs from the temperature sensor and the activation switch to determine when to provide electrical power to the supplemental heating element. The supplemental heating element is a ceramic heating element. The supplemental heating element is disposed within, a factory air box adjacent to the fan.

An activation element is provided that switches a flow of power from a battery to the heating element on and off, the activation element is controlled by the controller. The controller is connected in such a way that the controller receives inputs from the temperature sensor and the operable activation switch for the heating system. The controller is connected to an engine activation switch and provides power only when the engine is activated. A temperature sensor includes a temperature switch installed on the heater core that is responsive to a desired temperature of the heating fluid. The controller controls the provision of power to the heating element as a function of one or more of a signal received from a wireless transmitter, a sensed ambient temperature of the vehicle's passenger compartment, or a time determined by a clock.

The switch is connected to a battery such that the relay switch provides electrical power to the heating element from, the battery when, the heating system is activated and the sensed heating fluid temperature has not reached a desired temperature for heating the heater core. The switch is connected to an engine activation, circuit and only provides power to the heating element when the engine is activated. A ceramic heating element is placed in the factory air box.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram showing connections between a radiator, an engine, and a heater core for the flow of heating fluid to the heater core of a heating system for a passenger compartment of a vehicle;

FIG. 2 is a schematic of a heating system for a passenger compartment;

FIG. 3 is a flow diagram showing a process for fitting a vehicle with a supplemental heater; and

FIG. 4 is a schematic of a heating system for a passenger compartment including devices for transmitting and receiving signals used as inputs for the system.

Like reference symbols in the various drawings indicate like elements.

### DETAILED DESCRIPTION

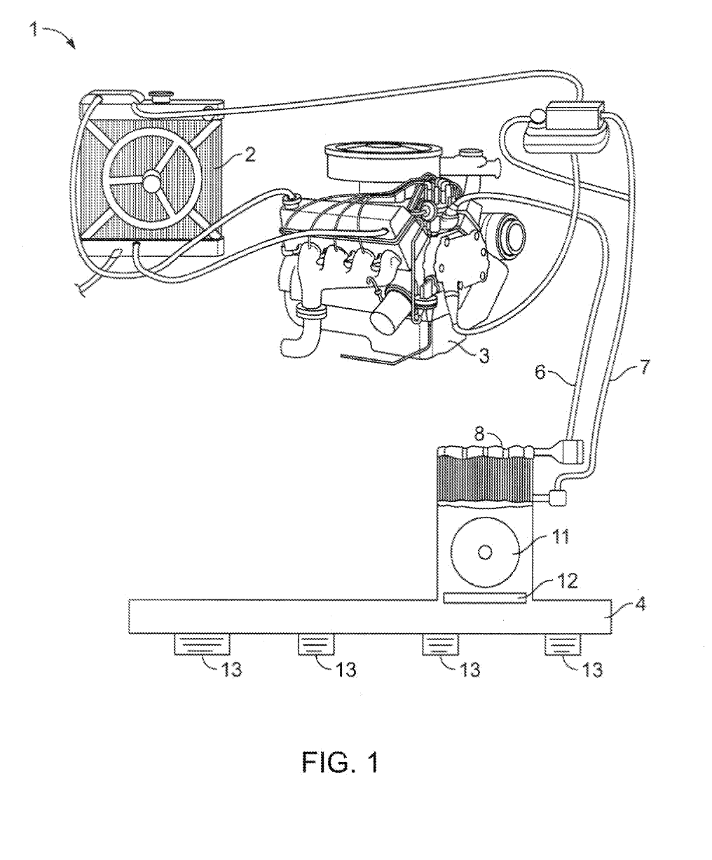

FIG. 1 shows a heating system 1 for a passenger compartment of a vehicle. The heating system 1 has a heating core 8 heated by radiator fluid from a radiator 2. The radiator fluid derives its heat from an engine 3, which generates heat through combustion and friction when running. However, a thermostat in the engine prevents fluid from circulating through the heater core until the radiator fluid reaches a certain temperature, usually in the range of 140 to 220° F. Thus, the heater core is not heated until the thermostat opens, allowing warm fluid to circulate through the heater core 8. The radiator fluid enters the heater core through a input hose 6, circulates through, the heater core raising its temperature, then exits through an output hose 7 to return to the radiator.

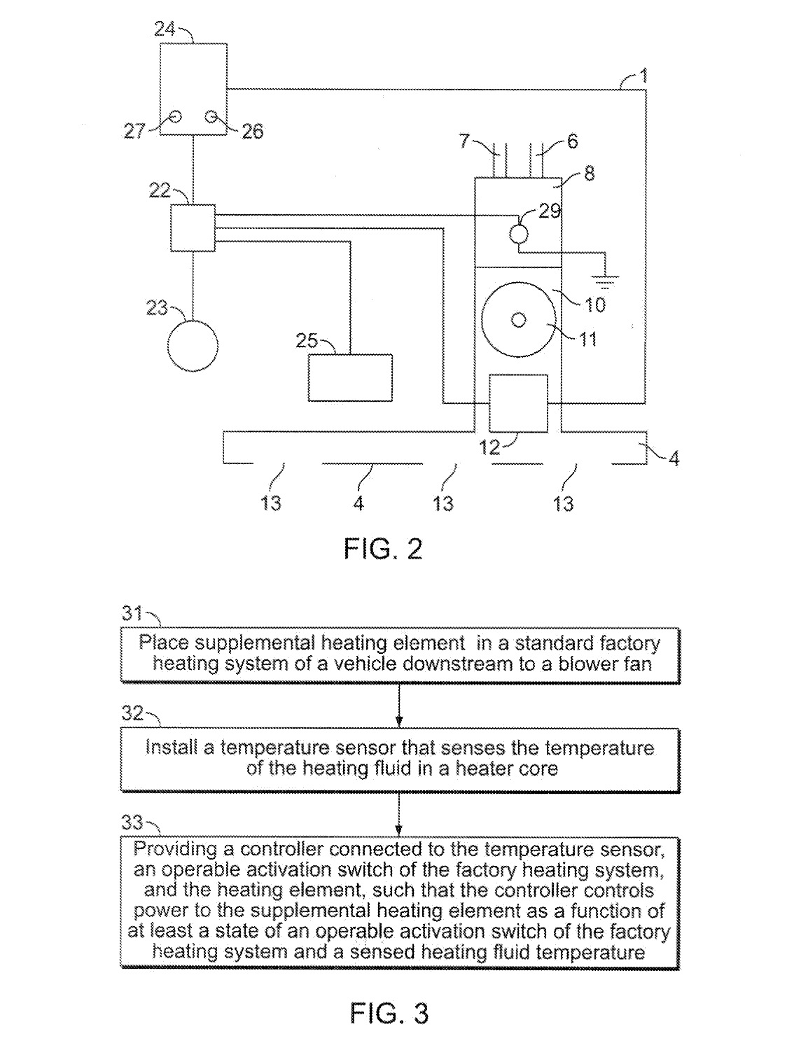

Referring to FIG. 2, heating system 1 is activated by a heater switch 25, which can be used to turn the heating system 1 on and off. When the heating system is activated (or turned on), a blower fan 11 pulls air through the heater core 8. If the thermostat in the radiator is not allowing the radiator fluid to circulate, then the temperature of heater core 8 is the same as the ambient temperature, and heater core 8 does not provide any heat to the air being pulled through it. Once the thermostat allows radiator fluid to circulate through the heater core 8, the temperature of the heater core 8 increases to essentially that of the radiator fluid passing through it. As the heater core 8 is heated, the air being pulled-through the heater core is warmed. Thus, there is a period of time (typically from about 1 to 7 minutes depending on the ambient temperature) when the air-entering the blower fan 11 from the heater core 8 is not heated.

During this period of time, blower fan 11 blows unheated air out towards a ventilation system 4, which carries the air to the passenger compartment of the vehicle through vents 13. This unheated air passes through, and is heated by a supplemental heating unit/beater/heating element 12 prior to passing into the passenger compartment, resulting in heated air, rather than unheated air being provided to any occupants in the passenger compartment during the time period when the heater core 8 is not being heated.

The heating element 12 is placed in front of the blower fen 11 between the blower fan and the passenger compartment for example in a blower box/factory air box 10. By placing the heating element 12 in front of the blower fan 11, the heating element 12 is not exposed to the outside environment as would occur if it were placed proximate to the heater core 8. By not placing the heating element 12 proximate to the heater core 8, where the heater core can absorb some of the heat produced by the heating element 12, more heat is available to heat the air entering the passenger compartment. In some embodiments, the heating element 12 is placed as close to the passenger compartment as possible. In some embodiments, the heating element 12 can be placed behind the blower fan if the factory air box is proportioned to accommodate such placement. In other embodiments, one or more supplemental heating elements and/or blower fans can be placed in other locations in the ventilation system 4 (adapted for such placement) to increase the heating of the passenger compartment and/or to accommodate design requirements of a vehicle's climate control system (such as for individualized climate control).

The heating element 12 can be made of any material compatible with being placed in the ventilation system of a vehicle, for example metallic heating element (nickel-Chromium and iron-chromium-aluminum), silicon, carbide, molybdenum disilicide, thermocouple wire, conductive alloys, fibrothal heating modules, tubothal heating elements, extruded tubes, semiconductor heating elements moduthal refectories, infrared heat, light heat, LED heating, incandescent heating, UV heating, band heaters, ceramic band heaters, mica band heater, tubular heaters, cartridge heaters, duct heaters, indirect, heaters radiant heaters, strip heaters, preferably a ceramic heating element. Heating element 12 can be dimensioned to fit in the chosen location in the heating system 1, such that essentially all of the air blown by the blower fan 11 passes through the heating element 12.

In some embodiments, the heating element 12 heats the air from the blower fan essentially from the time a driver turns the vehicle on until the time when the heater core 8 can provide the heat necessary to; heat the passenger compartment. This arrangement provides an efficient use of the supplemental heating element 12 such that the element does not draw power from a battery 24 except during the time period when the heater core cannot provide energy necessary to heat the passenger compartment.

The control unit 22, as a function of the inputs, determines the appropriate time period during which heating element 12 is powered on and off. In some embodiments, the control unit/controller 22 receives inputs from an engine activation circuit/starter/ignition switch 23 indicating the vehicle is activated and the engine is turned on, a heater switch 25 indicating the operable status of the heater system, and a temperature sensor 29 that senses the temperature of the heater core 8. The supplemental heating element 12 is turned on during the time period between starting the engine and the time the healer core 8 is up to a desired temperature. In this example the heating, element 12 is powered on when the engine is activated, the heating system is activated, and the temperature of the heating core has not reached a predetermined or desired temperature. The desired temperature can be in a range of approximately 140° to 220° F., for example approximately 160° F.

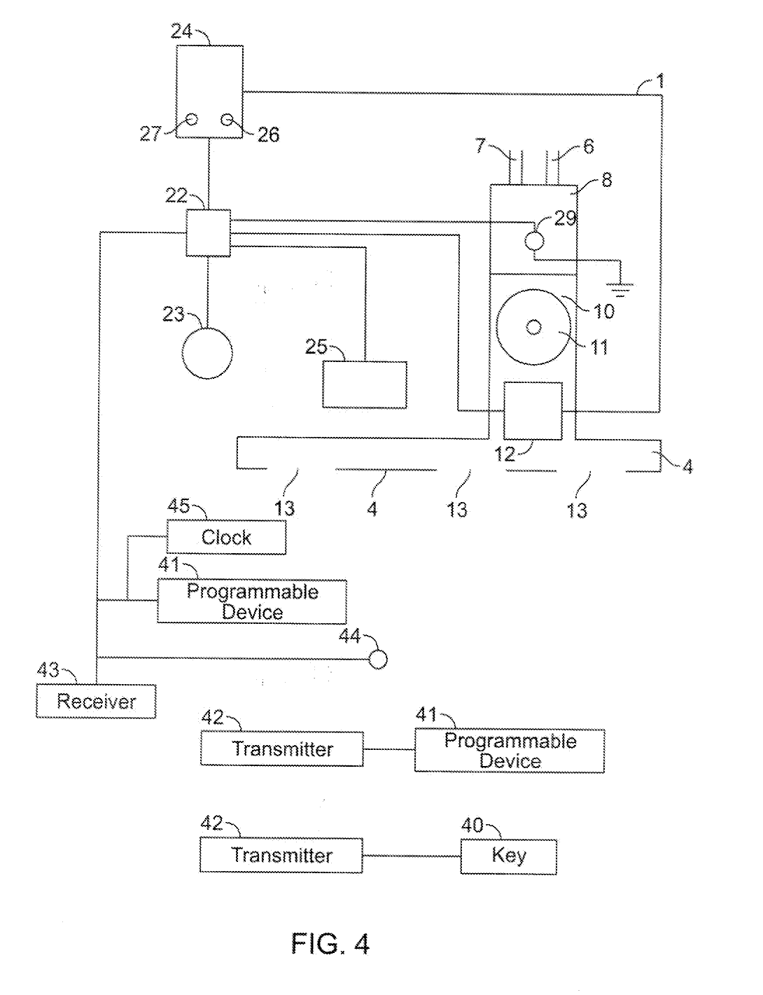

In other embodiments, as shown in FIG. 4, heating element 12 heats the air from the blower fan during a time period determined by the control unit/controller 22 as a function of one or more inputs/signals, which can include a signal from a user with an electronic key 40, and/or a manually activated switch, and/or a clock 45, and/or a passenger compartment temperature sensor 44, and/or a programmable device (either onboard or remote) 41 (such as a microprocessor, programmable logic circuit, etc.). The signal/input can be transmitted wirelessly (such as a signal transmitted over blue-tooth, radio frequency, Wi-Fi, or any other electromagnetic signal), using a transmitter 42 connected to the electronic key 40 or programmable device 41, etc., and a receiver 43 connected to the control unit 22.

For example, the control unit, using an input from the clock 45, can activate the heating element at a predetermined time. Using the wireless receiver 43 connected to the control unit 22, allows a signal to be sent from, a wireless transmitter 42 (connected to the electronic key, and/or the programmable device, and/or the temperature sensor, and/or the clock, etc) to the control unit to activate the heating element at a desired time as a function, of the inputs. For example, the electronic key 40 can be used to activate the transmitter 42 to send a signal through the receiver 43 to the control unit 22 activating the heating element 12 either by itself or in combination with other inputs (such as an input from a sensor that senses an ambient interior temperature of the vehicle, thus activating the heating element only if the ambient temperature of the passenger compartment is below a predetermined temperature). The receiver can also function to sense the proximity of the electronic key to the vehicle in order to activate the heating element 12 upon approach of the user with the electronic key.

In some embodiments, the heating element 12 receives power from a battery 24, which is a primary battery for powering the vehicle, when the inputs indicate that the heating element needs to be powered on. In other embodiments, the battery 24 can be an auxiliary battery. In other embodiments, the heating element 12 receives power from an alternate power source 24, such as an existing alternator, an upgraded alternator, and/or a capacitor and/or an additional energy generation/storage/regulation device 24. Power received by the heating element 12 may be increased, decreased, or otherwise modified or controlled by utilizing a capacitor or electrical metering or regulation device.

In some embodiments, the control unit 22 can be implemented through a relay switch acting as the control unit 22 with a positive connection of the heating element directly connected to a positive terminal 26 of the battery/power source 24 and a negative connection of the heating element is connected to the relay switch. The relay switch is also connected to the battery ground/body ground/negative terminal 27, to the starter/ignition activation switch 23 (indicating the vehicle is powered on), to the heater switch/factory heating system relay 25, and to the temperature sensor 29, which can be implemented as a temperature switch that turns off when the desired temperature is reached, placed at the heater core 8. (The temperature of the heater core 8 can be determined by sensing a temperature of the engine/engine block, radiator/radiator hose, water pump, or heater core 8 itself. The sensed temperature can be from the surface of a component (internal or external), or a fluid of the engine/engine block, radiator/radiator hose, water pump, or heater core.) The relay functions to power the heating element 12 when the following conditions are met; if the starter switch is on, the heating system is on, and the heater core 8 is not at or greater than, the desired temperature. However, if any of the conditions are not met then the relay switches off the heating element 12.

In other embodiments, inputs can be used such as proximity of an electronic key 40 to the vehicle, using a wireless signal/input sent from a transmitter 42, and/or an ambient interior temperature sensed by a temperature sensor 44 in the passenger compartment, and/or a signal/input from an internal or external clock 45, and/or a signal/input from a programmable device 41, etc.

In some embodiments, the control unit 22 can be implemented through an integrated circuit design, for example a microprocessor, which runs a program analyzing the one or more inputs, such as from, sensors relaying information about whether the engine is switched on or off, whether the heater system is switched on or off, whether the temperature of the heater core has reached the desired temperature, whether an electronic key 40 is in proximity to the vehicle, whether the ambient passenger compartment temperature is below a predetermined temperature, whether a predetermined time has passed, whether a user wishes to activate the heating element using a remote keypad or a switch, and/or whether some other condition programmed into a programmable device has occurred, etc. Based on the inputs, the program determines when the microprocessor sends signals for the heating element 12 to be powered on and off, for example through the activation of a relay switch that provides power to the heating element. In other embodiments, the integrated circuit is implemented through a gated or programmable logic circuit that determines when the heating element 12 is powered on and off as a function of the inputs. The control unit 22 can also be implemented through the electronic control unit of the vehicle.

The heating system can be entirely installed at the factory or the supplemental heating element 12 with the input circuitry and the control unit 22 can be added to a standard factory heating system, lacking these elements. For example, a supplemental heating element 12 is installed into the blower box of the standard factory installed heating system, having a heater core 8, ventilation system 4, and operable activation switch 25 that controls the heater. The supplemental heating element 12 is powered by a standard vehicle battery 24 and is fully integrated with the factory heating system. Using “clip-in” connectors connections can be made to the to the factory heating supply wires for heater switch 25, the ignition/engine activation switch 23. A temperature switch 29 can be added to the heater core to determine when a desired temperature is reached, and connections as discussed above can be made to a relay switch/control unit 22 and the battery 24. Additionally, the power supply for the heating element 12, i.e. the battery 24 can be the battery used to power the vehicle or it can be a secondary battery or alternative power source 24 (as discussed above), such that the heating element 12 does not drain power from the primary vehicle battery. If a secondary battery is present, it can have a battery isolator.

Referring to FIG. 3, a method of fitting a vehicle with a supplemental heater involves placing 31 a supplemental heating element 12 in a heating system of a vehicle. As used herein, “fitting” generally refers to installing in a vehicle during factory assembly or retrofitting an existing vehicle. That is, the heating system of the vehicle may be a heating system designed to be coupled with a supplemental heater during assembly of the vehicle or an existing standard factory heating system. In an example of retrofitting an existing standard factory heating system with a supplemental heater, the heating element 12 can be placed in the factory air box 10 downstream to a blower fan 11 such that the air from the blower fan 11 can be heated by the supplemental element 12 prior to its entering in a passenger compartment of the vehicle. A temperature sensor is installed 32 that monitors the temperature of heating fluid in a factory heater core 8. Connecting 33 a controller to the temperature sensor, an operable activation, switch of the factory heating system, and the heating element, such that the controller controls the power to the supplemental heating element 12 as a function of a state of an operable activation switch 25 of the heating system, and/or the sensed temperature of the heating fluid, and/or the state of the ignition/engine activation switch 23. The controller 22 can be a relay switch that controls power to the hearing element. The relay switch is connected to a battery 24 that supplies the power. The relay switch is also connected to input sources that determine whether power is provided, i.e. as a function of the temperature sensor/switch in the heater core, and/or the heater activation switch and/or the ignition/engine activation switch.

A number of embodiments of the invention have been described. Nevertheless, it will be understood that various modifications may be made without departing from the spirit and scope of the invention. Accordingly, other embodiments are within the scope of the following claims.

What is claimed is:

1. A vehicle passenger compartment heating system comprising:
a fan producing air flow;
a heater core mat receives heated, heating fluid and is disposed upstream of the fan, such that air is drawn through the heater core by the fan for heat exchange with the heating fluid;
a ventilation system directing the air flow produced by the fan throughout the passenger compartment;
a supplemental heating element disposed in the ventilation system and arranged to heat air flow produced by the fan; and
a hearing system controller that controls electrical power to the supplemental heating element as a function of a state of an operable activation switch and sensed, heating fluid temperature.

2. The heating system according to claim 1 wherein the supplemental heating element is disposed downstream of the fan.

3. The heating system according to claim 1 wherein the controller is configured to provide power to the supplemental heating element only when the activation switch is engaged and the sensed temperature is less than about 160° F.

4. The heating system according to claim 1 wherein the controller is configured to provide power to the supplemental heating element only when the activation switch is engaged and the sensed temperature is less than about 140° F.

5. The heating system according to claim 1 wherein the supplemental heating element is operably connected to a battery that supplies electrical power to the heating system.

6. The heating system according to claim 1 wherein the controller controls electrical power to the heating element as a function of one or more of a signal received from a wireless transmitter, a sensor that senses an ambient temperature of the vehicle's passenger compartment, or a clock at a predetermined time.

7. The heating system according to claim 5 wherein the controller comprises one or more relay switches connecting the supplemental heating element to the battery and controlled by heating fluid temperature and the activation switch.

8. The heating system according to claim 6 wherein the controller comprises a microprocessor running a program that analyzes inputs from the temperature sensor, and the activation switch to determine when to provide electrical power to the supplemental, heating element.

9. The heating system according to claim 1 wherein the supplemental heating element comprises a ceramic heating element.

10. The heating system according to claim 1 wherein the supplemental heating element is disposed within a factory air box adjacent to the fan.

11. A method of modifying a factory vehicle heating system in a vehicle having a passenger compartment, the method comprising:
placing a heating element in a factory air box between a factory blower fan and the passenger compartment;
installing a temperature sensor to sense a heater core temperature; and
providing a controller such that the controller controls the provision of power to the heating element as a function of at least a state of an operable activation switch, for the heating system and sensed heater core temperature.

12. The method according to claim 11 comprising providing an activation element that switches a (low of power from a battery to the heating element on and off, the activation element being controlled by the controller.

13. The method according to claim 11 further comprising connecting the controller such that the controller receives inputs from the temperature sensor and the operable activation switch for the heating system.

14. The method according to claim 13 further comprising connecting the controller to an engine activation switch such that power is provided to the heating element only when the engine is activated.

15. The method according to claim 11 wherein installing a temperature sensor comprises installing a temperature switch on the heater core responsive to a desired temperature of the heating fluid.

16. The method according to claim 11 wherein providing the controller further comprises controlling the provision of power to the heating element as a function of one or more of a signal received from a wireless transmitter, a sensor that senses an ambient temperature of the vehicle's passenger compartment, era clock at a predetermined time.

17. A method of fitting a vehicle heating system, the method comprising:
placing a heating element in a factory air box between a factory blower fan and a passenger compartment;
installing a temperature switch on a factory heater core to sense a heating fluid temperature in the core; and
connecting a switch to the heating element such that electrical power is provided to the heating element as a function of at least a state of an operable activation switch for the heating system and sensed heating, fluid temperature.

18. The method according to claim 17 further comprises connecting the switch to a battery such that the relay switch provides electrical power to the heating element from, the battery when the heating system is activated and the sensed heating fluid temperature has not reached a desired temperature for heating the heater core.

19. The method according to claim 17 wherein connecting the switch further comprises connecting the switch to an engine activation circuit such that the switch only provides power to the heating element when the engine is activated.

20. The method according to claim 17 wherein placing the heating element comprises placing a ceramic heating element in the factory air box.
